(19) United States
(12) Patent Application Publication
(10) Pub. No.: US 2007/0297001 A1
(43) Pub. Date: Dec. 27, 2007

(54) Multi-function peripheral remote alert notification system and method

(76) Inventor: Brian Podl, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/473,645

(22) Filed: Jun. 22, 2006

(51) Int. Cl. G06F 3/12; G08B 1/00; G08B 1/08

(52) U.S. Cl. 358/1.15; 340/539.18; 340/531

(57) ABSTRACT

A remote alert notification system and method is disclosed. An alert condition is detected in a multi-function peripheral (MFP) having a communications interface. An alert message indicative of the alert condition is assembled. Information associated with one or more recipients that have registered with the MFP to be notified when the alert condition is present is retrieved, and a list of recipients based on the retrieved information is assembled. The alert message is sent to a wireless mobile device associated with each recipient in the list of recipients. The alert message, which can be sent via the communications interface, can be a stored voice message or a short message service message sent to a short message service center.

### BACKGROUND OF THE INVENTION

1. Field of the Invention

The invention relates to alert notification, and more particularly, to remote alert notification for multi-function peripheral devices.

2. Description of the Related Art

A multi-function peripheral (MFP) device is an office or home machine that typically includes a printer, scanner, copier and a facsimile (fax) capability. The MFP is an electronic device and is also known as a multi-function printer or product, a multifunctional, an all-in-one (AiO), a mopier or a multifunction device (MFD). Some MFP devices do not include the fax capability, while in other MFP devices, the fax capability is optional. Some MFP devices can include a media card reader capability and/or one or more hard disks. Existing MFP devices have limited remote alert notification abilities. Typically, remote alert notification is only available on a personal computer connected to the MFP via a computer network. The remote alert notification is typically provided through a print driver of the MFP, remote user interface (UI) client software, or via a web browser client. The user must have a computer on the network and may need to have special software installed. A MFP user using this prior technique is required to be near a computer to receive prompt notification.

### SUMMARY OF THE INVENTION

The system and method relates to enhanced remote alert notification for a user of a MFP. The user can be notified of an error or status condition from the MFP via a short message service (SMS) text message device, telephone voice device or other communication device. A MFP can be connected to a phone line for voice message alerts and can also use SMS technology or other communication technology for the sending of an alert message from the MFP to a text message client, which is typically a user's cell phone.

In one embodiment, there is a remote alert notification method, comprising detecting an alert condition in a multi-function peripheral (MFP), assembling an alert message indicative of the alert condition, retrieving information associated with one or more recipients that have registered with the MFP to be notified when the alert condition is present, assembling a list of recipients based on the retrieved information, and sending the alert message to a mobile device associated with each recipient in the list of recipients.

The method can additionally comprise registering a particular recipient to receive one or more selected message types. The message types can comprise warnings and errors. The method can additionally comprise registering a particular recipient to receive the alert message using a particular voice message telephone number. The method can additionally comprise registering a particular recipient to receive to receive the alert message using a particular text message telephone number. The mobile device can comprise a cellular telephone. Sending the alert message can comprise sending the alert message to a short message service center. Alternatively, sending the alert message can comprise sending a stored voice message corresponding to the alert message. The method can additionally comprise sending the alert message to a networked computer associated with at least one recipient in the list of recipients.

In another embodiment, there is a remote alert notification system, comprising a multi-function peripheral (MFP) having a communications interface; and a software program executed by the MFP and configured to detect an alert condition in a multi-function peripheral (MFP), assemble an alert message indicative of the alert condition, retrieve information associated with one or more recipients that have registered with the MFP to be notified when the alert condition is present, assemble a list of recipients based on the retrieved information, and send the alert message to a mobile device associated with each recipient in the list of recipients. The alert message can be sent through the communications interface.

In another embodiment, there is a computer usable medium having computer readable program code embodied therein for performing remote alert notification, the computer readable code comprising instructions for detecting an alert condition in a multi-function peripheral (MFP), assembling an alert message indicative of the alert condition, retrieving information associated with one or more recipients that have registered with the MFP to be notified when the alert condition is present, assembling a list of recipients based on the retrieved information, and sending the alert message to a mobile device associated with each recipient in the list of recipients.

In yet another embodiment, there is a remote alert notification method, comprising detecting an alert condition in a multi-function peripheral (MFP), and transmitting to a wireless mobile device a message indicative of the alert condition. The method can additionally comprise assembling the message indicative of the alert condition. The method can additionally comprise retrieving information associated with one or more recipients to be notified when the alert condition is present, and assembling a list of recipients based on the retrieved information. The transmitting can comprise transmitting the message to a wireless mobile device associated with each recipient in the list of recipients. The one or more recipients to be notified can comprise recipients that have registered with the MFP. Transmitting the message can comprise sending the message through a short message service center. Transmitting the message can comprise sending a stored voice message corresponding to the message. The retrieved information can comprise a message type desired to be received by the registered recipients. The retrieved information can comprise a voice message telephone number corresponding to a particular recipient. Alternatively, the retrieved information can comprise a text message telephone number corresponding to a particular recipient.

### BRIEF DESCRIPTION OF THE DRAWINGS

FIG. 1 is a diagram of an exemplary configuration of an embodiment of the remote alert notification system.

FIG. 2 is a diagram of certain components of the MFP shown in FIG. 1.

FIG. 3 is a screen display of an exemplary remote alert setup menu or dialog box used in the system shown in FIG. 1.

FIG. 4 is a flowchart of an exemplary remote alert notification process such as used in the system shown in FIG. 1.

### DETAILED DESCRIPTION OF CERTAIN EMBODIMENTS

The following detailed description of certain embodiments presents various descriptions of specific embodiments of the invention. However, the invention can be embodied in a multitude of different ways as defined and covered by the claims. In this description, reference is made to the drawings wherein like parts are designated with like numerals throughout.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The system is comprised of various modules, tools, and applications as discussed in detail below. As can be appreciated by one of ordinary skill in the art, each of the modules may comprise various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system modules, tools, and applications may be written in any programming language such as, for example, C, C++, BASIC, Visual Basic, Pascal, Ada, Java, HTML, XML, or FORTRAN, and executed on an operating system, such as variants of Windows, Macintosh, UNIX, Linux, VxWorks, or other operating system. C, C++, BASIC, Visual Basic, Pascal, Ada, Java, HTML, XML and FORTRAN are industry standard programming languages for which many commercial compilers can be used to create executable code.

A network may refer to a network or combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), General Packet Radio Service (GPRS), frequency division multiple access (FDMA), or third generation or newer mobile communication systems, such as Universal Mobile Telecommunications System (UMTS) or CDMA2000 based on the International Mobile Telecommunications-2000 (IMT-2000) standard, among others.

### System Configuration

The system and method enhances existing methods of remote alert notification by utilizing communication technology such as text messaging via SMS or telephone voice technology to send messages from the MFP to the user. The ability for a MFP user to be notified from the MFP via their cell phone or other mobile communication device, such as a Pocket PC or a handheld computing device with communications capability, in addition to or in place of notification via a networked computer allows the user greater convenience and mobility. The MFP user may not always be near a computer, but can carry their cell phone so that their cell phone is always available. Using the system and method, the MFP user prefers to be notified of an MFP alert via a text message to their cell phone so that they are notified promptly no matter where they are. Using prior methods, a MFP user is required to be near a computer to receive prompt notification.

The system and method enhances remote alert notification by taking advantage of cell phones or other voice/text communication devices that are typically available in an office. The MFP may be configured to send messages to any number of voice/text communication devices. Typical messages sent would be error conditions such as “out of paper” or “paper jam” that need prompt attention. However messages do not need to be limited to error conditions. The MFP could also be used for other messages, such as for example, paging a user.

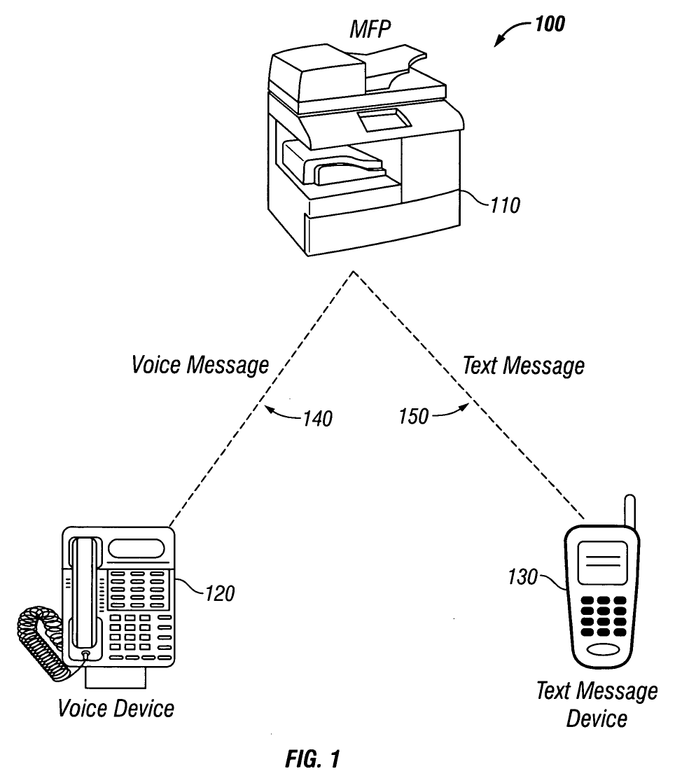

Referring to FIG. 1, a remote alert notification system 100 comprises a MFP 110 connected to any number of voice communication devices, such as voice device 120, and text message communication devices, such as text message device 130. The connections may be wired, such as connection 140, or wireless, such as connection 150. Transmitter communication components (not shown), such as a telephone unit, may be built into the MFP 110 or external to the MFP. One embodiment of the transmitter communication components functions as a wireless base station.

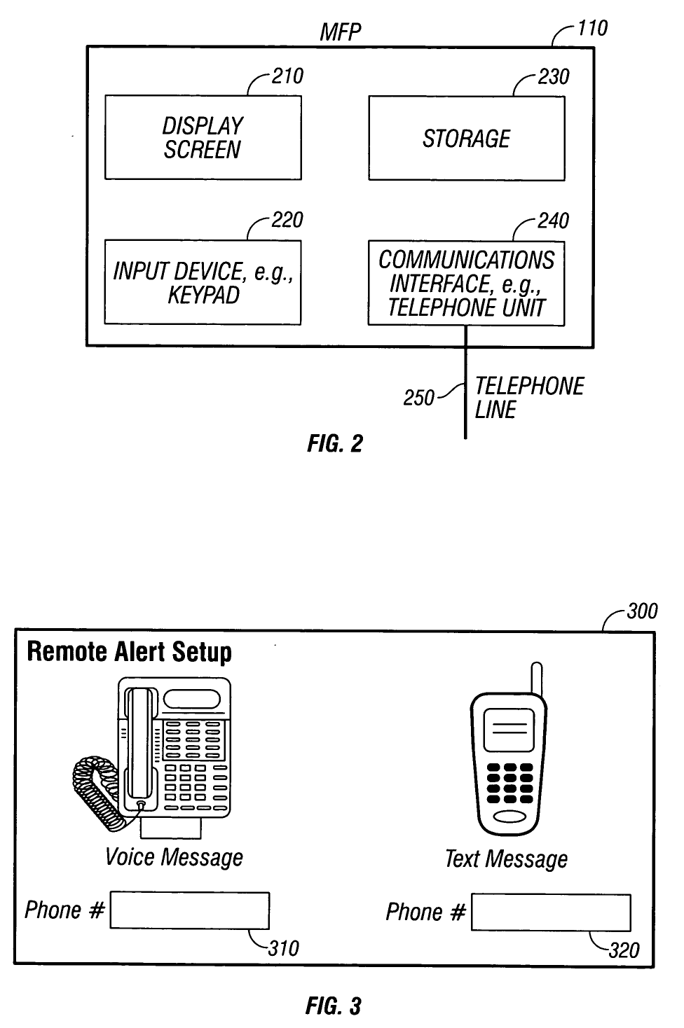

Referring to FIG. 2, portions of a typical MFP, such as MFP 110, will be described. A typical MFP has a connection to a telephone line 250. Therefore any telephone receiving device can potentially receive a message from a MFP. In certain embodiments, a telephone or communications unit 240 of the MFP has built-in/stored voice messages for error and status conditions. In another embodiment, the voice messages can be stored in a storage 230. The telephone unit 240 also has the ability to connect with a Short Message Service Center (SMSC) through either a wired or wireless connection so that text based messages can be sent to a user. The SMSC is a network element in a mobile telephone network which delivers SMS messages. When the MFP sends a text message (SMS message) to a user, the peripheral actually sends the message to the SMSC. The SMSC stores the message and then delivers it to the destination user when they are available, as a store and forward operation.

### Example Messages and Setup

An example of a remote alert notification text message is as follows:

MFP: MFP1

Location: Mail Room

Message: Load Letter in Tray 1

### A message such as the above message can also be assembled into an equivalent voice message if the MFP has voice capabilities.

In one embodiment, setup of remote alert notification is done by registering the remote communication devices with the MFP 110 (FIG. 1). Referring to FIG. 3, a setup menu or dialog box 300 such as displayed on a display screen 210 (FIG. 2) on the MFP can be used to enter telephone numbers of the remote devices, such as devices 120 and/or 130. An input device 220 (FIG. 2), such as a keypad, on the MFP 110 can be used to enter a telephone number in a voice message box 310 and/or a text message box 320.

Further sub-menus can be used to register for more specific events or event types. The notification messages can be organized into several categories and a particular user can register for the messages that they wish to receive. For example, messages can be split into the following sub-categories, and the menu can have selections as listed:

| Message Type: | Message Example: |
|---|---|
| Maintenance Warnings | Order Toner Cartridge |
| Maintenance Errors | Replace Toner Waste Cartridge |
| Paper Warnings | Tray 1 Paper Low |
| Paper Errors | Load Paper in Tray 1 |
| (Etc.) | |

Menu Selections: <Choose one or more Message Types>
All Messages
All Errors
All Warnings
Only Maintenance Warnings
Only Maintenance Errors
Only Paper Warnings
Only Paper Errors
(Etc.)

### Remote Alert Notification Process

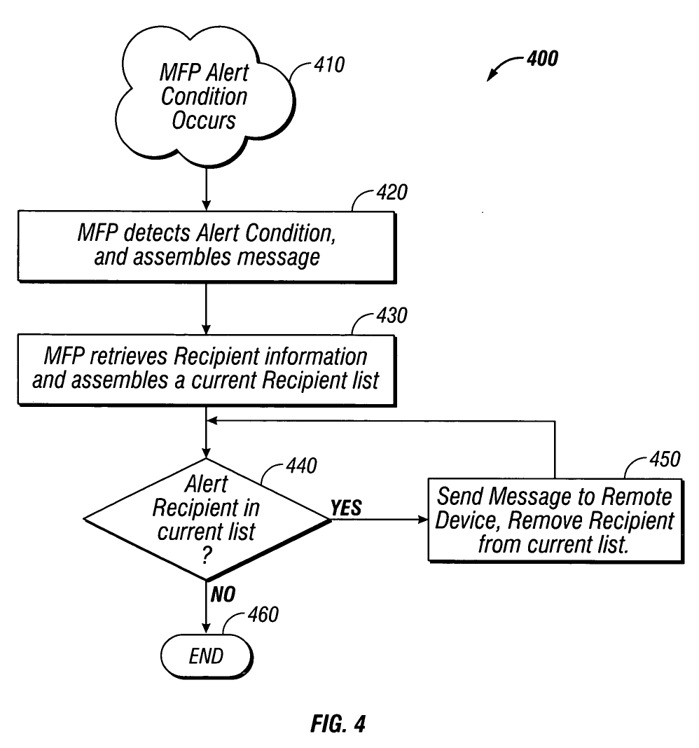

Referring to FIG. 4, a remote alert notification process 400 on the MFP 110 (FIG. 1) will be described. In certain embodiments, the remote alert notification process 400 is a software program executed by the MFP 110. When a condition of interest arises in the MFP 110, remote alert notification is performed. The MFP compiles a list of notification recipients to contact from its internal storage 230 (FIG. 2) matching the condition that occurred with the event types that each recipient has registered for. The MFP then transmits remote alert notification messages to all devices registered (corresponding to the registered recipients), such as devices 120 and/or 130 (FIG. 1).

Beginning at a state 410, a MFP alert condition occurs in the MFP 110 (FIG. 1). Advancing to state 420, remote alert notification process 400 detects the alert condition and assembles an alert message. Proceeding to state 430, process 400 retrieves recipient information based on users that have registered for the particular MFP 110 and assembles a current recipient list. Moving to a decision state 440, process 400 determines if a particular alert recipient is in the current recipient list. If so, process continues at state 450 and sends the alert message via the communications components of the MFP 110. The particular alert recipient is then removed from the current recipient list, and process 400 moves back to decision state 440 to determine if another alert recipient is in the current recipient list. When the current recipient list is empty, as determined at decision state 440, process 400 completes at an end state 460.

### Alternative Embodiments

The system and method includes an embodiment where the notification device specified may be another device, telephone or text message client if the MFP has the capability to communicate with these devices. Examples of alternative devices that may be used are: walkie-talkie radio, Bluetooth or other wireless protocol device, or a traditional paging device. The message can also be sent via a computer network via email or instant messaging, for example.

The system and method includes an embodiment where multiple remote alert notifications may be entered in a menu for the particular notification desired.

The system and method includes an embodiment where the source of the alert notification may be a client connected to the MFP 110 (FIG. 1). The MFP may receive the client message, process it and then send a remote alert message to the intended receiver. The outgoing message could be a copy of the original message (forward) or a newly assembled message using data transmitted to the MFP and/or data stored on the MFP.

### CONCLUSION

While specific blocks, sections, devices, functions and modules may have been set forth above, a skilled technologist will realize that there are many ways to partition the system, and that there are many parts, components, modules or functions that may be substituted for those listed above.

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

What is claimed is:

1. A remote alert notification method, comprising:
detecting an alert condition in a multi-function peripheral (MFP);
assembling an alert message indicative of the alert condition;
retrieving information associated with one or more recipients that have registered with the MFP to be notified when the alert condition is present;
assembling a list of recipients based on the retrieved information; and
sending the alert message to a mobile device associated with each recipient in the list of recipients.

2. The method of claim 1, additionally comprising registering a particular recipient to receive one or more selected message types.

3. The method of claim 2, wherein the message types comprise warnings and errors.

4. The method of claim 1, additionally comprising registering a particular recipient to receive the alert message using a particular voice message telephone number.

5. The method of claim 1, additionally comprising registering a particular recipient to receive to receive the alert message using a particular text message telephone number.

6. The method of claim 1, wherein the mobile device comprises a cellular telephone.

7. The method of claim 1, wherein sending the alert message comprises sending the alert message to a short message service center.

8. The method of claim 1, wherein sending the alert message comprises sending a stored voice message corresponding to the alert message.

9. The method of claim 1, additionally comprising sending the alert message to a networked computer associated with at least one recipient in the list of recipients.

10. A remote alert notification system, comprising:
a multi-function peripheral (MFP) having a communications interface; and
a software program executed by the MFP and configured to:
detect an alert condition in a multi-function peripheral (MFP),
assemble an alert message indicative of the alert condition,
retrieve information associated with one or more recipients that have registered with the MFP to be notified when the alert condition is present,
assemble a list of recipients based on the retrieved information, and
send the alert message to a mobile device associated with each recipient in the list of recipients.

11. The system of claim 10, wherein the alert message is sent through the communications interface.

12. A computer usable medium having computer readable program code embodied therein for performing remote alert notification, the computer readable code comprising instructions for:
detecting an alert condition in a multi-function peripheral (MFP);
assembling an alert message indicative of the alert condition;
retrieving information associated with one or more recipients that have registered with the MFP to be notified when the alert condition is present;
assembling a list of recipients based on the retrieved information; and
sending the alert message to a mobile device associated with each recipient in the list of recipients.

13. A remote alert notification method, comprising:
detecting an alert condition in a multi-function peripheral (MFP); and
transmitting to a wireless mobile device a message indicative of the alert condition.

14. The method of claim 13, additionally comprising assembling the message indicative of the alert condition.

15. The method of claim 13, additionally comprising:
retrieving information associated with one or more recipients to be notified when the alert condition is present; and
assembling a list of recipients based on the retrieved information.

16. The method of claim 15, wherein transmitting comprises transmitting the message to a wireless mobile device associated with each recipient in the list of recipients.

17. The method of claim 15, wherein the one or more recipients to be notified comprise recipients that have registered with the MFP.

18. The method of claim 13, wherein transmitting the message comprises sending the message through a short message service center.

19. The method of claim 13, wherein transmitting the message comprises sending a stored voice message corresponding to the message.

20. The method of claim 17, wherein the retrieved information comprises a message type desired to be received by the registered recipients.

21. The method of claim 15, wherein the retrieved information comprises a voice message telephone number corresponding to a particular recipient.

22. The method of claim 15, wherein the retrieved information comprises a text message telephone number corresponding to a particular recipient.
